(19) United States
(12) Patent Application Publication
(10) Pub. No.: US 2026/0219717 A1
(43) Pub. Date: Jul. 30, 2026

(54) OPERATION SUPPORT DEVICE, OPERATION SUPPORT METHOD, AND RECORDING MEDIUM

(71) Applicant: NEC Corporation, Tokyo (JP)

(72) Inventor: Koki YASUMOTO, Tokyo (JP)

(73) Assignee: NEC Corporation, Tokyo (JP)

(21) Appl. No.: 19/443,262

(22) Filed: Jan. 8, 2026

(30) Foreign Application Priority Data
Jan. 28, 2025 (JP) 2025-011914

(51) Int. Cl. G06F 1/28

(52) U.S. Cl. CPC G06F 1/28

(57) ABSTRACT

An operation support device includes at least one memory configured to store instructions and at least one processor configured to execute the instructions to: design a plurality of configuration candidates of a service operable disaggregated (DAG) node based on a resource amount of prediction necessary for operation of a service to be operated in a prediction target period for the service to be operated in a DAG system; estimate a total power consumption including migration power required when migration to a configuration candidate of the DAG node is performed and power consumption during operation in the configuration candidate of the DAG node for each of the plurality of configuration candidates; and control the DAG system to operate the service using a configuration of the DAG node selected from among the plurality of configuration candidates based on the power consumption calculated for each configuration candidate.

This application is based upon and claims the benefit of priority from Japanese Patent Application No. 2025-011914, filed on Jan. 28, 2025, the disclosure of which is incorporated herein in its entirety by reference.

### TECHNICAL FIELD

The present disclosure relates to an operation support device and the like.

### BACKGROUND ART

In general, a system that operates a service includes an integrated information processing device, as one unit, obtained by combining devices such as a central processing unit (CPU), a read only memory (ROM), a random access memory (RAM), and a hard disk drive (HDD) necessary for executing a software program and a graphics processing unit (GPU), an auxiliary arithmetic device specialized for a specific application, or the like, and is configured by combining a plurality of the integrated information processing devices as necessary.

When the integrated information processing devices are combined, network connection or the like via a network interface card (NIC) mounted on the integrated information processing device is used. A plurality of integrated information processing devices connected to each other exchange data with each other as necessary, so that the integrated information processing devices can be operated as a single system.

There has been proposed an idea of operating not an integrated information processing device but a system in which devices constituting the information processing device are connected to each other and can be recombined in units of devices. The host-target application instance appears to be running on a virtual information processing device that is configured by collecting devices required for its operation. A system including devices, which are components necessary for constituting a virtual information processing device, and a mechanism for connecting these devices to operate is called a disaggregated (DAG) system.

For example, JP 2021-135625 A describes an example of designing a configuration of a DAG system.

### SUMMARY

In operating a service in the DAG system, it is desired to further reduce power consumption.

An object of the present disclosure is to provide an operation support device and the like that reduce power consumption when operating a service in a DAG system.

An operation support device according to an aspect of the present disclosure includes
a design means for designing a plurality of configuration candidates of a service operable DAG node based on a resource amount of prediction necessary for operation of a service to be operated in a prediction target period for the service to be operated in a DAG system,
an estimation means for estimating a total power consumption of a migration power in a case where a migration to a configuration candidate of the DAG node is performed for each of a plurality of configuration candidates of the DAG node and power consumption in a case where operation is performed in the configuration candidate of the DAG node, and
a control means for controlling the DAG system to operate the service using a configuration of the DAG node selected from among a plurality of configuration candidates of the DAG node based on the power consumption calculated for each of the plurality of configuration candidates of the DAG node.

An operation support method according to an aspect of the present disclosure causes at least one computer to execute
designing a plurality of configuration candidates of a service operable DAG node based on a resource amount of prediction necessary for operation of a service to be operated in a prediction target period for the service to be operated in a DAG system,
estimating a total power consumption of a migration power in a case where a migration to a configuration candidate of the DAG node is performed for each of a plurality of configuration candidates of the DAG node and power consumption in a case where operation is performed in the configuration candidate of the DAG node, and
controlling the DAG system to operate the service using a configuration of the DAG node selected from among a plurality of configuration candidates of the DAG node based on the power consumption calculated for each of the plurality of configuration candidates of the DAG node.

A program according to one aspect of the present disclosure causes at least one computer to execute
designing a plurality of configuration candidates of a service operable DAG node based on a resource amount of prediction necessary for operation of a service to be operated in a prediction target period for the service to be operated in a DAG system,
estimating a total power consumption of a migration power in a case where a migration to a configuration candidate of the DAG node is performed for each of a plurality of configuration candidates of the DAG node and power consumption in a case where operation is performed in the configuration candidate of the DAG node, and
controlling the DAG system to operate the service using a configuration of the DAG node selected from among a plurality of configuration candidates of the DAG node based on the power consumption calculated for each of the plurality of configuration candidates of the DAG node.

The program may be stored in a non-transitory recording medium readable by the at least one computer.

### BRIEF DESCRIPTION OF THE DRAWINGS

FIG. 1 is an explanatory diagram illustrating an example of a system including an operation support device;

FIG. 2 is an explanatory diagram illustrating a configuration example of a DAG node;

FIG. 3 is an explanatory diagram illustrating an example of device allocation to a node NA of an application AA;

FIG. 4 is an explanatory diagram (part 1) illustrating an example of a change from a node NA to a node NA′;

FIG. 5 is an explanatory diagram (part 2) illustrating an example of a change from a node NA to a node NA′;

FIG. 6 is an explanatory diagram (part 3) illustrating an example of a change from a node NA to a node NA′;

FIG. 7 is a diagram for explaining total power consumption at the time of migration;

FIG. 8 is a block diagram illustrating a configuration example of an operation support device;

FIG. 9 is an explanatory diagram illustrating an example of a requested resource amount of an application;

FIG. 10 is an explanatory diagram illustrating an exemplary configuration candidate of a DAG node;

FIG. 11 is an explanatory diagram illustrating an example of a search result;

FIG. 12 is an explanatory diagram illustrating a comparative example of configuration candidates;

FIG. 13 is an explanatory diagram illustrating an example in which a plurality of configuration candidates of the DAG node are designed using different predetermined intervals;

FIG. 14 is a flowchart illustrating an exemplary operation of the operation support device;

FIG. 15 is a flowchart illustrating a search example of a configuration candidate of a DAG node by the operation support device;

FIG. 16 is a flowchart illustrating an estimation example of power consumption by the operation support device;

FIG. 17 is a block diagram illustrating a configuration example of the operation support device;

FIG. 18 is an explanatory diagram illustrating an example of data acquired as resource usage amount data;

FIG. 19 is a flowchart illustrating an exemplary operation of the operation support device;

FIG. 20 is an explanatory diagram illustrating an example of a system including the operation support device;

FIG. 21 is a block diagram illustrating a configuration example of the operation support device;

FIG. 22 is a flowchart illustrating an exemplary operation of the operation support device; and

FIG. 23 is an explanatory diagram illustrating a hardware configuration example of a computer.

### EXAMPLE EMBODIMENT

Hereinafter, example embodiments of an operation support device, an operation support method, a program, and a non-transitory recording medium recording the program according to the present disclosure will be described in detail with reference to the drawings. Each example embodiment does not limit the disclosed technique.

### First Example Embodiment

In a first example embodiment, basic functions of an operation support device will be described in detail with reference to the drawings.

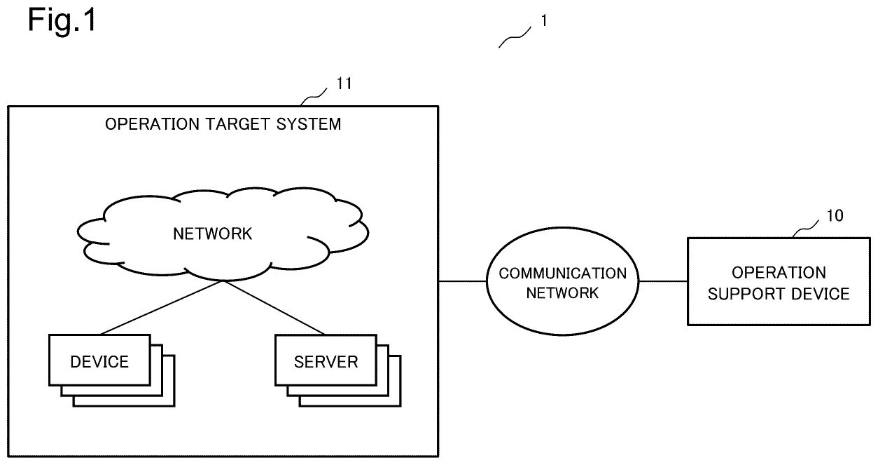

FIG. 1 is an explanatory diagram illustrating an example of a system including the operation support device. A system 1 includes, for example, an operation target system 11 and an operation support device 10. The operation target system 11 is a DAG system. For example, the DAG system is a system including devices which are components necessary for constituting a virtual information processing device, and a mechanism for connecting these devices to each other and operating them. The DAG system can operate as a virtual information processing device by connecting all components necessary for operating as an integrated information processing device. This virtual information processing device is referred to as a DAG node or a node.

The operation support device 10 determines allocation of devices to a service operated in the operation target system 11. The service operated in the operation target system 11 is implemented by being executed by the device to which the application instance is allocated. The number of application instances that operate each service is not particularly limited.

Here, the configuration of the DAG node and a change example of the configuration of the DAG node will be described.

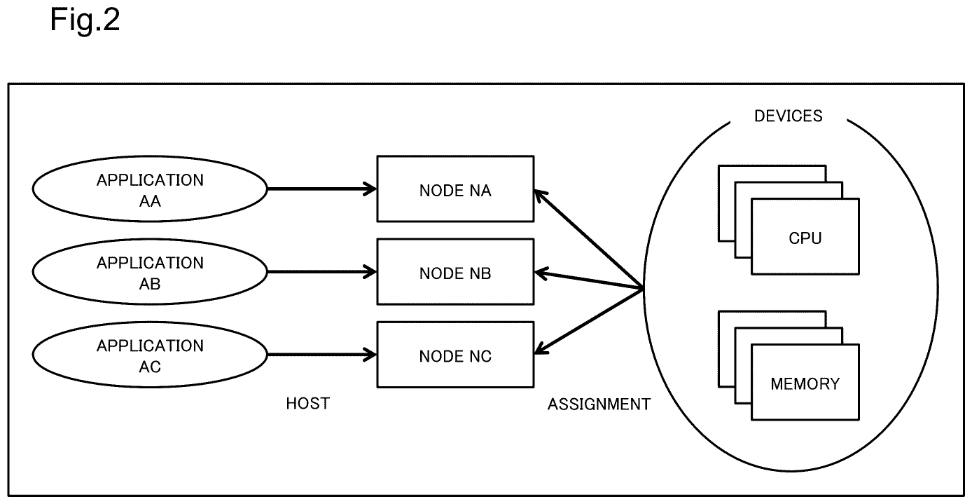

FIG. 2 is an explanatory diagram illustrating a configuration example of the DAG node. In FIG. 2, applications AA, AB, and AC are exemplified as services operated in the operation target system 11. The applications AA, AB, and AC are application instances that operate the service.

Although a CPU and a memory are illustrated for simplicity of description, other devices such as a GPU and a storage may be included. Specifically, allocation of a device to a node and stop and operation of the node may be performed by a controller or the like included in the DAG system. Since an existing technique may be used for the controller, detailed description thereof is omitted.

The node NA, the node NB, and the node NC are DAG nodes. That is, the node NA, the node NB, and the node NC are virtual information processing devices. For example, the node NA executes the application AA. For example, the node NB executes the application AB. For example, the node NC executes the application AC. A resource capable of operating an application executed by each of the node NA, the node NB, and the node NC is allocated from the devices.

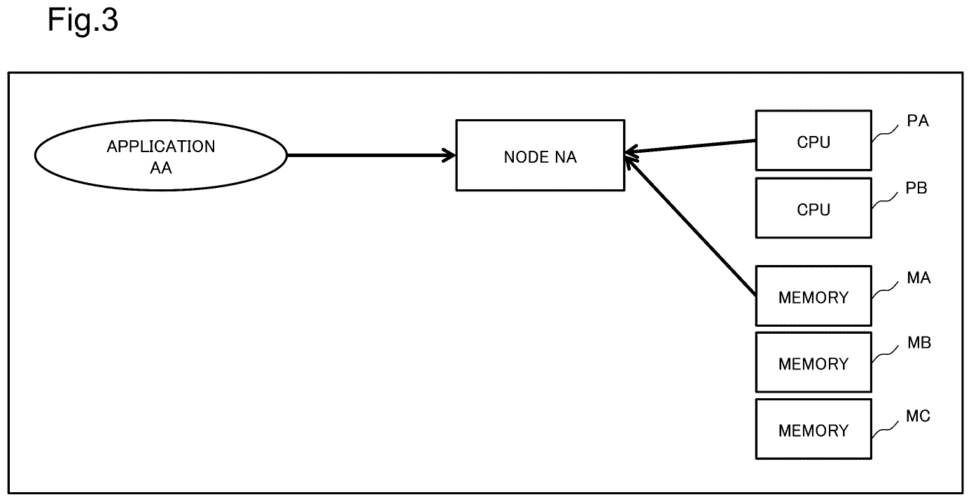

FIG. 3 is an explanatory diagram illustrating an example of device allocation to the node NA of the application AA. In FIG. 3, the application AA is hosted in the node NA to which a CPU PA and a memory MA are allocated.

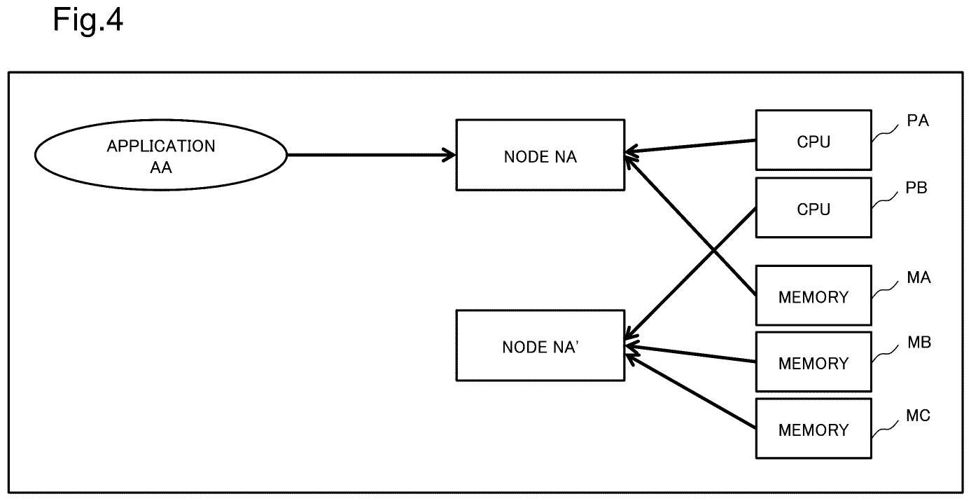

FIG. 4 is an explanatory diagram (part 1) illustrating an example of a change from the node NA to a node NA′. For example, it is assumed that an increase in the load of the application AA is predicted, and more resources are required. Therefore, it is necessary to newly configure the node NA′ that can cover the requested resource amount of the application AA. For example, a CPU PB, a memory MB, and a memory MC are allocated to the node NA′.

Here, the resource amount may be represented by, for example, the performance of the processor, the capacity of the memory, or the like.

The application AA is migrated to be hosted at node NA′. Since a specific migration method is an existing technology, detailed description thereof is omitted, but as the migration process, an application deployment process, a startup process, or the like is performed on the node NA′.

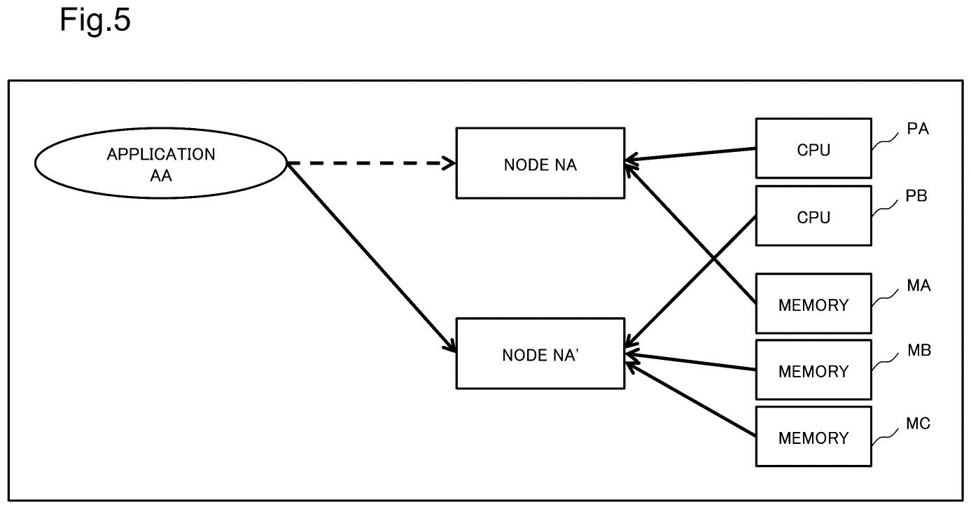

FIG. 5 is an explanatory diagram (part 2) illustrating an example of a change from the node NA to the node NA′. In order to migrate the service of the application AA without stopping, it is necessary to operate the node NA in parallel until the node NA′ is ready to host the application AA. When the node NA′ is ready to host the application AA, the node NA is stopped.

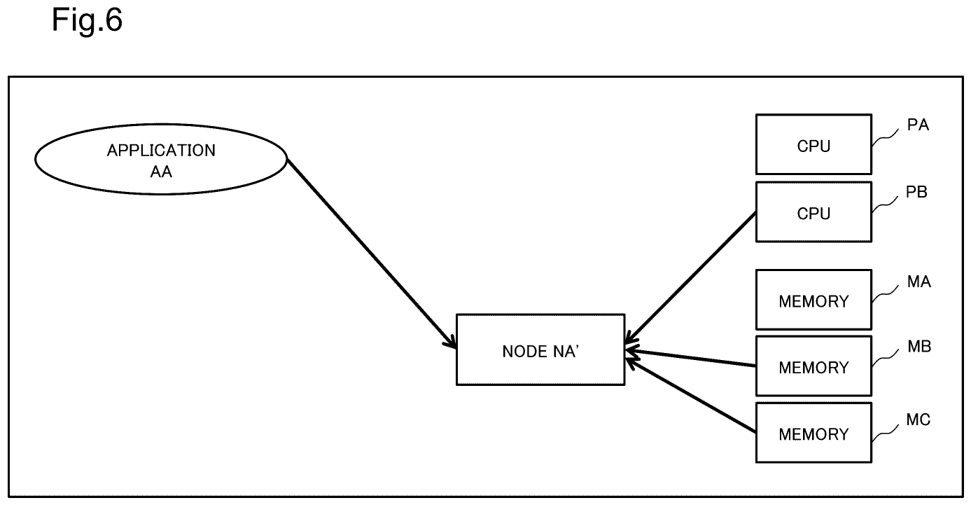

FIG. 6 is an explanatory diagram (part 3) illustrating an example of a change from the node NA to the node NA′. When the node NA is stopped, the device allocation to the node NA is released, and the node NA is deleted. As a result, the configuration of the node for the application is changed.

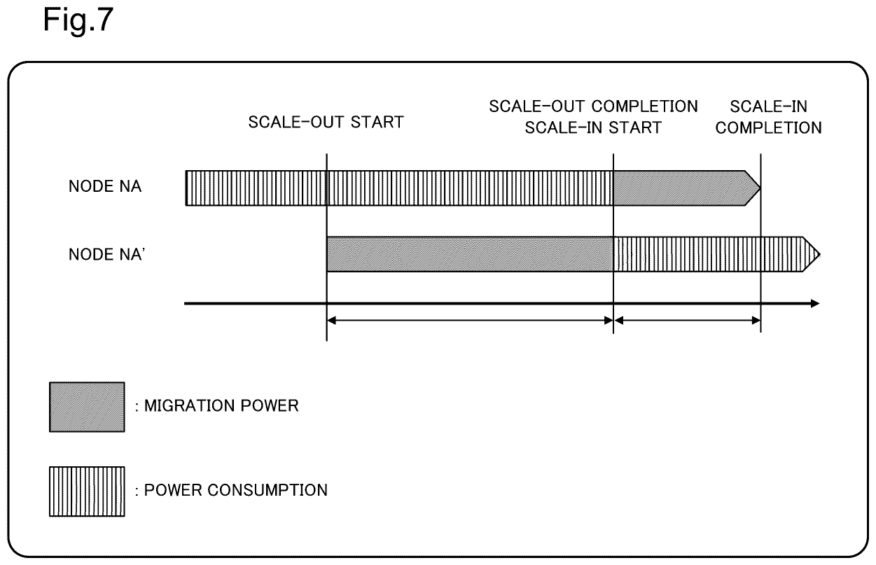

FIG. 7 is a diagram for explaining the total power consumption at the time of migration. While the node NA and the node NA′ are operated in parallel, the application AA is not hosted in any of the nodes. However, even in this state, power to be consumed is applied to the node. This power is referred to as migration power. In FIG. 7, for example, the power consumption of the node NA′ from the start of scale-out to the completion of scale-out and the power consumption of the node NA from the start of scale-in to the completion of scale-in are the migration power. For example, the migration power in the case of migration from the node NA to the node NA′ can be calculated as in the following Expression 1.

$$[ Power consumption of node NA ] \times [ Time required for scale - in ] + [ Power consumption of {NA}^{′} ] \times [ Time required for scale - out ] \qquad Expression 1$$

The power consumption of the node NA and the power consumption of the node NA′ are power consumption per unit time.

When the configuration is changed, the migration power is consumed. For example, even if the configuration is changed to reduce the power consumption, if the migration power is included, the power consumption may conversely increase.

A detailed method of calculating the migration power will be described with reference to the functional block diagram.

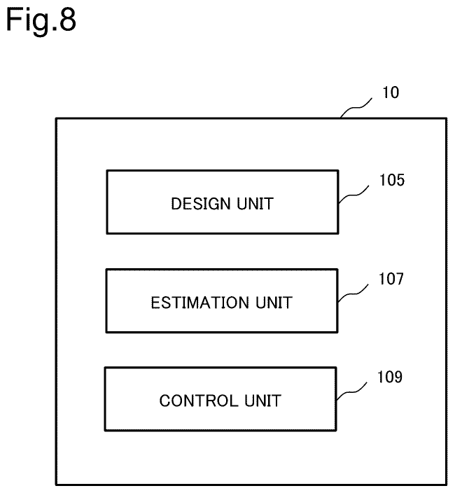

FIG. 8 is a block diagram illustrating a configuration example of the operation support device 10. The operation support device 10 includes a design unit 105, an estimation unit 107, and a control unit 109.

The design unit 105 designs a plurality of configuration candidates of the service operable DAG node based on the resource amount of the prediction necessary for the operation of the service in the prediction target period for the service to be operated in the operation target system 11. The prediction target period may be an arbitrary value, and may be set according to the type or characteristic of the service.

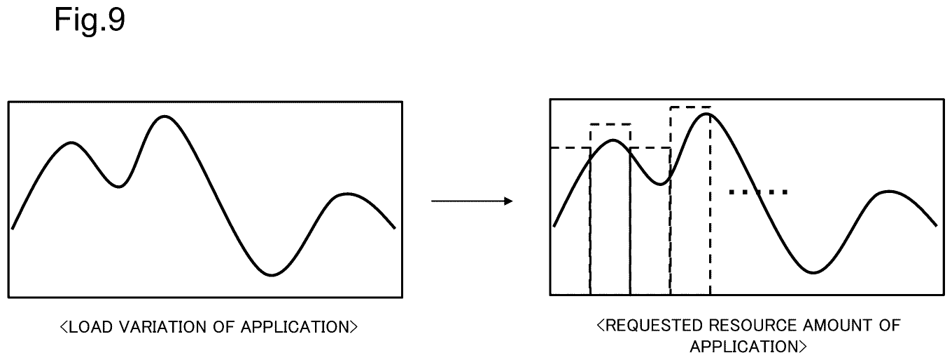

FIG. 9 is an explanatory diagram illustrating an example of a requested resource amount of an application. The graph representing the load variation of the application represents the load of the application in time series. A graph representing the requested resource amount of the application in FIG. 9 represents the resource amount of the prediction necessary for the operation of the application in time series. The resource amount necessary for the operation of the application is also referred to as a requested resource amount. According to FIG. 9, there is a possibility that the requested resource amount increases as the load increases.

The design unit 105 uses various constraints to be considered in determining a combination of an application and a device as inputs, and designs a configuration plan of a DAG node that hosts the application based on the various constraints. The design unit 105 only needs to use an existing technology to configure the DAG node so as to satisfy the resource amount of the prediction, and thus a detailed description thereof will be omitted.

Here, the design unit 105 may design a plurality of configuration candidates of the DAG node based on the configuration plan of the DAG node in each of the plurality of sections in which the prediction target period is divided at predetermined time intervals. The predetermined time may be an arbitrary value, and may be set according to the type or characteristic of the service. Here, for example, a configuration in each section in which the prediction target period is divided is set as a configuration plan, and a series of configurations in the prediction target period is set as a configuration candidate.

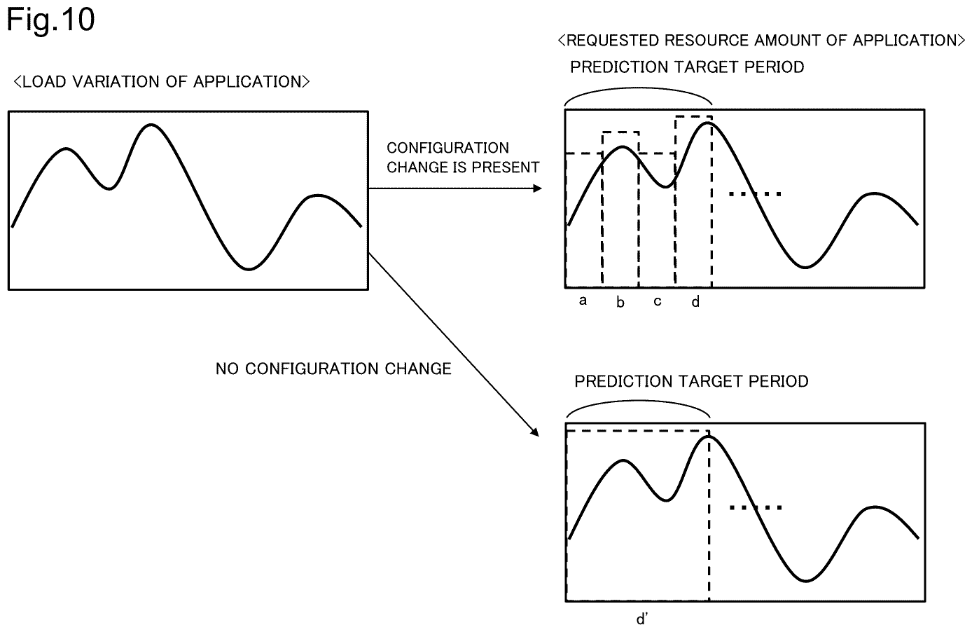

FIG. 10 is an explanatory diagram illustrating an exemplary configuration candidate of a DAG node. In FIG. 10, the prediction target period is divided into four sections every predetermined time. For example, the design unit 105 designs the configuration of the DAG node so as to satisfy the prediction request resource for each of the four sections.

For example, when there is a configuration change in the prediction target period, a configuration plan a of the node is designed for the first section, a configuration plan b of the node is designed for the second section, a configuration plan c of the node is designed for the third section, and a configuration plan d of the node is designed for the fourth section. The configuration plans a to d of the nodes are examples of configuration candidates of the DAG node in the prediction target period. On the other hand, for example, in a case where there is no configuration change in the prediction target period, a configuration plan d′ of the node is designed. The configuration plan d′ of the node is another example of the configuration candidate of the DAG node in the prediction target period. The configuration plan d of the node and the configuration plan d′ of the node have the same configuration.

More specifically, for example, the design unit 105 may design a plurality of configuration candidates of the DAG node by searching for configuration candidates of the DAG node that can be taken in the prediction target period based on a configuration plan of the DAG node in each of a plurality of sections in which the prediction target period is divided for each predetermined time. In this search processing, for example, the design unit 105 may design a plurality of configuration candidates of the DAG node depending on whether to adopt a configuration plan of the DAG node in each of the plurality of sections. The plurality of configuration candidates of the DAG node may be all searchable candidates, may be at least some of searchable candidates, or may be a predetermined number of candidates. As described above, the number of the plurality of configuration candidates of the DAG node is not particularly limited as long as it is two or more.

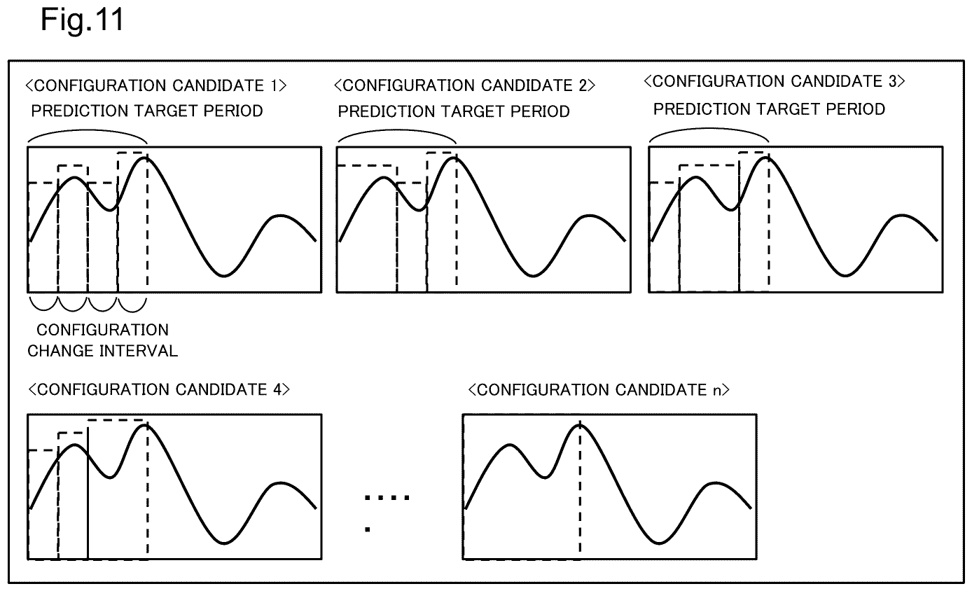

FIG. 11 is an explanatory diagram illustrating an example of a search result. For example, the prediction target period is divided into a plurality of sections at predetermined time intervals. The design unit 105 designs a configuration plan of the DAG node for each of the plurality of sections. As described above, the configuration plan a of the node is designed for the first section, the configuration plan b of the node is designed for the second section, the configuration plan c of the node is designed for the third section, and the configuration plan d of the node is designed for the fourth section.

For example, the configuration candidate 1 of the DAG node is a candidate in which the configuration plan of the DAG node is adopted for all the sections. The configuration candidate 1 is the same as the configuration candidate with the configuration change illustrated in FIG. 10. For example, a configuration candidate 2 of the DAG node is a candidate in which the configuration plan of the node is not adopted for the first section and the configuration plan of the node is adopted for the second to fourth sections. For example, a configuration candidate 3 of the DAG node is a candidate in which the configuration plan of the node is not adopted for the third section and the configuration plan of the node is adopted for the first, second, and fourth sections. For example, a configuration candidate 4 of the DAG node is a candidate in which the configuration plan of the node is not adopted for the third section and the configuration plan of the node is adopted for the first, second, and fourth sections. A configuration candidate n is a candidate for which a configuration change is not performed and is the same as the candidate without a configuration change illustrated in FIG. 10.

Next, the estimation unit 107 estimates the total power consumption of the migration power in a case where the migration to the configuration candidate of the DAG node is performed for each of the plurality of configuration candidates of the DAG node and the power consumption in a case where the operation is performed in the configuration candidate of the DAG node.

The estimation unit 107 calculates power consumption in the case of operation with the configuration candidate of the DAG node. Calculating the power consumption means calculating the power consumption amount. As a method of calculating the power consumption, an existing technique may be used.

The estimation unit 107 calculates the migration power. As described above, for example, the estimation unit 107 calculates the migration power using the time required for scale-in of the node of the migration source and the time required for scale-out of the node of the migration destination. The estimation unit 107 calculates the migration power as in the following Expression 2.

$$Migration power = [ Power consumption per unit time of node of migration source ] \times [ Time required for scale - in ] + [ Power comsumption per unit time of node of migration destination ] \times [ Time required for scale - out ] \qquad Expression 2$$

Therefore, for example, the estimation unit 107 first estimates the time required for scale-in of the node of the migration source and the time required for scale-out of the node of the migration destination.

For example, the time required for scale-in of the node of the migration source may be a fixed value. For example, the estimation unit 107 may estimate a statistical value of actual measured values of the time required for scale-in in the same application or a similar application as the time required for scale-in. The statistical value is an average value, a mode value, a maximum value, a minimum value, or the like.

The estimation unit 107 may estimate the time required for scale-in of the node of the migration source using the learned model. The estimation unit 107 may estimate the time required for scale-in based on the type of service and the type of the device included in the configuration of the DAG node using the learned model. Here, the learned model is a model in which the relationship between the type of service operated in the past and the type of the device included in the configuration of the DAG node when the service operated in the past is executed in the operation target system 11 that is the DAG system, and the actual measured value of the time required for scale-in when the service operated in the past is executed is learned. That is, the objective variable is the time taken required for scale-in, and the explanatory variable is the type of service and the type of the device. The type of the device may be, for example, a broad category of devices such as a memory and a processor, or may be a small category such as a detailed product of a specific device. The type of service may be, for example, a type determined by characteristics or requirements of the service. Specific examples of the type of service include a web service, a search service, a database service, and a messaging service. The type of service may be read as the type of application.

Methods of estimating the time required for scale-in may be combined, and are not limited to the above example.

The time required for scale-out of the node of the migration destination may be estimated similarly to the time required for scale-in of the node of the migration source. For example, the time required for scale-out of the node of the migration destination may be a fixed value. For example, the estimation unit 107 may estimate a statistical value of actual measured values of the time required for scale-out in the same application or a similar application as the time required for scale-out. The statistical value is an average value, a mode value, a maximum value, a minimum value, or the like.

The estimation unit 107 may estimate the time required for scale-out of the node of the migration destination using the learned model. Specifically, for example, the estimation unit 107 estimates the time required for scale-out based on the type of service and the type of the device included in the configuration of the DAG node using the learned model. The learned model is a model in which the relationship between the type of service operated in the past and the type of the device included in the configuration of the DAG node when the service operated in the past is executed in the operation target system 11 that is the DAG system, and the actual measured value of the time required for scale-out when the service operated in the past is executed is learned. That is, the objective variable is the time taken required for scale-out, and the explanatory variable is the type of service and the type of the device.

Methods of estimating the time required for scale-out may be combined, and are not limited to the above example.

For example, the learned model capable of outputting the time required for scale-in and the learned model capable of outputting the time required for scale-out may output fixed values in an initial state, and optimization may be performed by additional learning in both cases.

The learned model capable of outputting the time required for scale-in and the learned model capable of outputting the time required for scale-out may be one learning model.

Next, an estimation example of the total power consumption will be described using a configuration candidate 1 with the configuration change in FIG. 10 and a configuration candidate n without the configuration change. The power consumption of each DAG node configuration is represented as power consumption pa and power consumption pb. For the configuration candidate 1, migration power is generated at the timing of changing the configuration from the configuration plan a to the configuration plan b and from the configuration plan b to the configuration plan c. Such migration power is represented as migration power pab and migration power pbc.

It is estimated that the power consumption of the configuration plan d and the configuration plan d′ having the largest requested resource amount is the largest. Therefore, when the migration power is not taken into consideration, the power consumption reduction effect is higher when the configuration is changed. However, as described above, migration power is actually generated. Therefore, the total power consumption for the configuration candidate 1 in which all the configuration plans in each section are adopted is expressed as the following Expression 3.

$$Total power consumption for configuration candidate 1 = Power consumption pa \times Node operation time ta + Power consumption pb \times Node operating time tb + Power consumption pc \times Node operation time tc + Power consumption pd \times Node operating time td + Migration power pab + Migration power pbc + Migration power pcd \qquad Expression 3$$

On the other hand, the migration power for the configuration candidate n whose configuration is not changed is expressed as the following Expression 4.

$$Total power consumption for configuration candidate n = Node power consumption {pd}^{′} \times Node operating time {td}^{′} \qquad Expression 4$$

As described above, it is estimated that the power consumption decreases in a case where the configuration is changed without considering the migration power. However, in a case where the migration power is taken into consideration, there is a possibility that the power consumption is conversely increased by the configuration change depending on the magnitude of the migration power and the power consumption reduction amount of the configuration change itself.

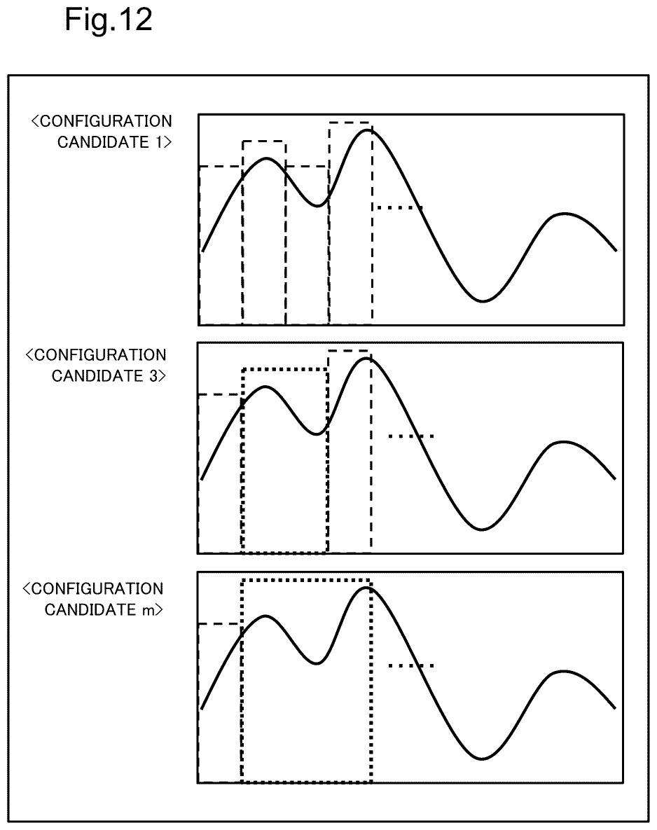

FIG. 12 is an explanatory diagram illustrating a comparative example of configuration candidates. Here, an example of comparing the configuration candidate 1, the configuration candidate 3, and the configuration candidate m will be described. The configuration candidate 1 is an example in which the configuration is designed according to the resource amount required in each of the plurality of sections divided for each predetermined time. Therefore, in the configuration candidate 1, the migration power is applied every time the configuration is changed.

The configuration candidate 3 is an example that is not changed to the configuration plan of the third section. In the configuration candidate 3, even if the resources can be reduced by the configuration change, it is also conceivable that the migration power exceeds. Therefore, depending on the migration power, the power consumption of the configuration candidate 3 may be lower than that of the configuration candidate 1.

The configuration candidate m is an example in which the configuration plan for the fourth section is adopted from the second section to the fourth section without adopting the configuration plan for the second section and the configuration plan for the third section. The configuration candidate m allocates more resources in advance in anticipation of a requested resource amount slightly later in the prediction target period. As a result, in the configuration candidate m, the total power consumption may be reduced as compared with the configuration candidate 1 and the configuration candidate 3.

There may be a plurality of predetermined times. As a result, a plurality of configuration candidates of the DAG node may be designed.

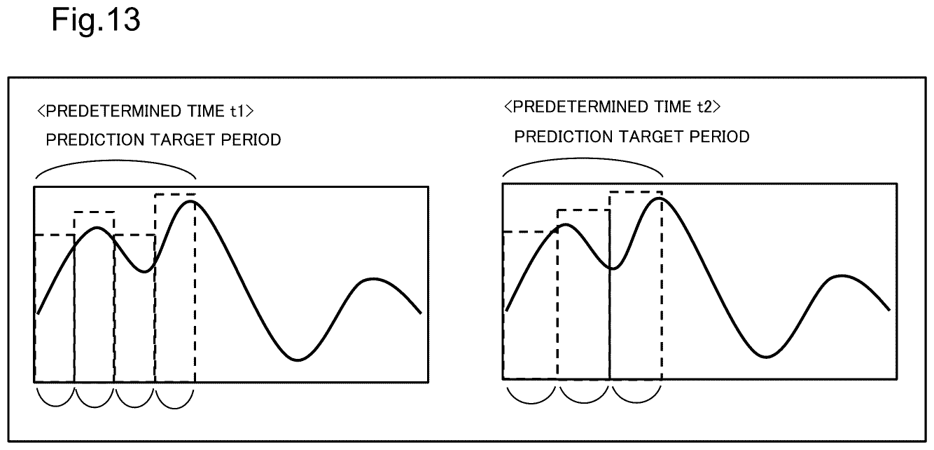

FIG. 13 is an explanatory diagram illustrating an example in which a plurality of configuration candidates of the DAG node are designed using different predetermined intervals. FIG. 13 illustrates an example in which a prediction target section is divided into four sections by a predetermined time t1 and an example in which the prediction target section is divided into three sections by a predetermined time t2. In this manner, the design unit 105 may design a plurality of configuration candidates of the DAG node by making the predetermined time different. As a result, the design unit 105 can design a plurality of configuration candidates of the DAG node at different predetermined times.

An example in which a plurality of configuration candidates of the DAG node is designed for the same predetermined time may be combined with an example in which configuration candidates of the DAG node are designed by making the predetermined time different.

In the above example, an example has been described in which the configuration of the DAG node is determined by calculating and then comparing the power consumption for all the candidates for the DAG node. For example, the configuration of the DAG node may be determined using an algorithm such as a game tree or reinforcement learning. As a search method in a case where there are an option and an evaluation function in which there are a selection as to whether to adopt the configuration plan and a function for evaluating power consumption, there is a game tree. Reinforcement learning can be cited as an algorithm that can learn and determine a configuration change candidate that minimizes power consumption with respect to an input such as a type of a device or a service and load tendency prediction. Using the processing of the design unit 105 and the estimation unit 107, the design unit 105 may determine the configuration of the DAG node using a game tree or reinforcement learning. At this time, the processing of the estimation unit 107 and the design unit 105 may be repeated.

The control unit 109 controls the operation target system 11 to operate the service using the configuration of the DAG node selected from among the plurality of configuration candidates of the DAG node based on the power consumption calculated for each of the plurality of configuration candidates of the DAG node. The control unit 109 may select the configuration of the DAG node, or the administrator may select the configuration of the DAG node. Here, an example in which the control unit 109 selects the configuration of the DAG node will be described. An example in which the administrator selects the configuration of the DAG node will be described using the third example embodiment.

Specifically, for example, the control unit 109 may select the configuration of the DAG node having the lowest power consumption calculated for each of the plurality of configuration candidates of the DAG node from the plurality of configuration candidates of the DAG node, and control the operation target system 11 to operate the service using the selected configuration of the DAG node. Specifically, for example, the control unit 109 may control the operation target system 11 to select a configuration of any DAG node from among configuration candidates of the DAG node in which the power consumption calculated for each of the plurality of configuration candidates of the DAG node is equal to or less than a predetermined amount from among the plurality of configuration candidates of the DAG node, and operate the service using the configuration of the selected DAG node. Specifically, for example, the control unit 109 instructs the controller included in the operation target system 11 to execute the application by the configuration of the DAG node. Then, the controller included in the operation target system 11 operates, stops, or the like the DAG node according to the instruction of the control unit 109.

### (Flowchart)

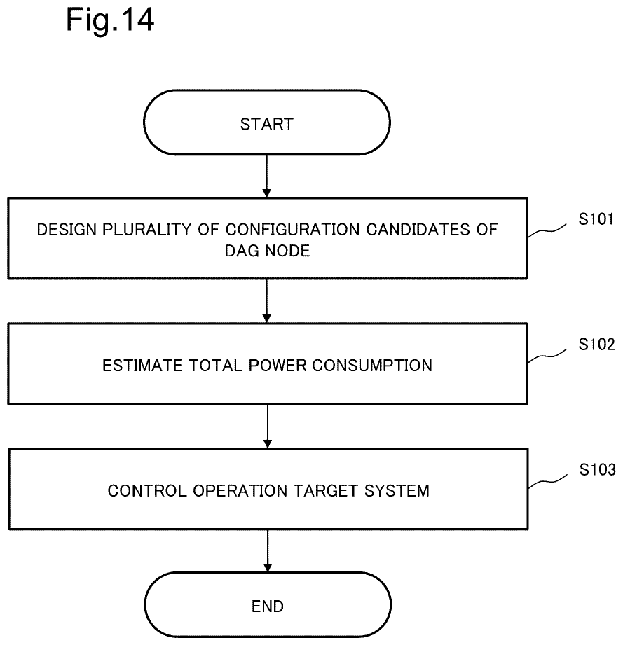

FIG. 14 is a flowchart illustrating an exemplary operation of the operation support device 10. The design unit 105 designs a plurality of configuration candidates of the service operable DAG node based on the resource amount of the prediction necessary for the operation of the service in the prediction target period for the service to be operated in the operation target system 11 (step S101). Next, the estimation unit 107 estimates the total power consumption of the migration power in a case where the migration to the configuration candidate of the DAG node is performed for each of the plurality of configuration candidates of the DAG node and the power consumption in a case where the operation is performed in the configuration candidate of the DAG node (step S102).

The control unit 109 controls the operation target system 11 to operate the service using the configuration of the DAG node selected from among the plurality of configuration candidates of the DAG node based on the power consumption calculated for each of the plurality of configuration candidates of the DAG node (step S103). Then, the operation support device 10 ends a series of processes illustrated in FIG. 14.

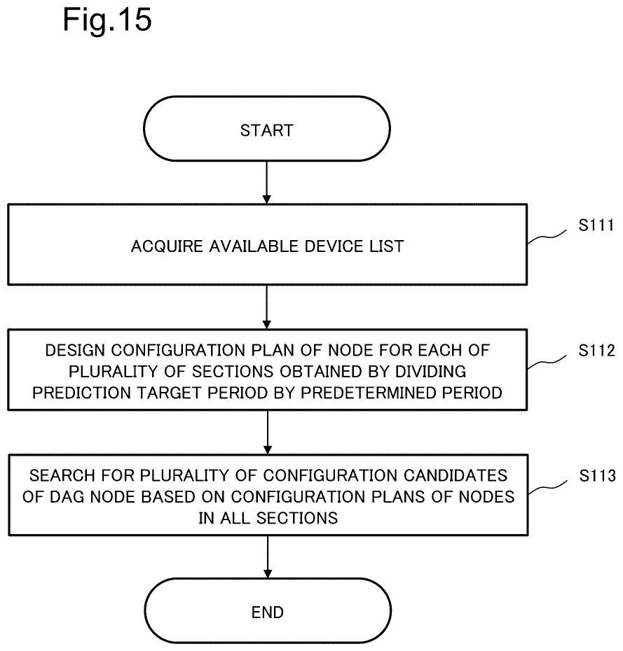

FIG. 15 is a flowchart illustrating a search example of a configuration candidate of a DAG node by the operation support device 10. FIG. 15 is a detailed example of step S102 illustrated in FIG. 14, and a search example illustrated in FIG. 11 will be described. The design unit 105 acquires an available device list (step S111).

Next, the design unit 105 designs a configuration plan of a node for each of a plurality of sections obtained by dividing the prediction target period by a predetermined period (step S112). The design unit 105 searches for a plurality of configuration candidates of the DAG node based on the configuration plans of the nodes in all the sections (step S113). As a result, the design unit 105 can design a plurality of configuration candidates of the DAG node. Then, the design unit 105 ends a series of processes illustrated in FIG. 15.

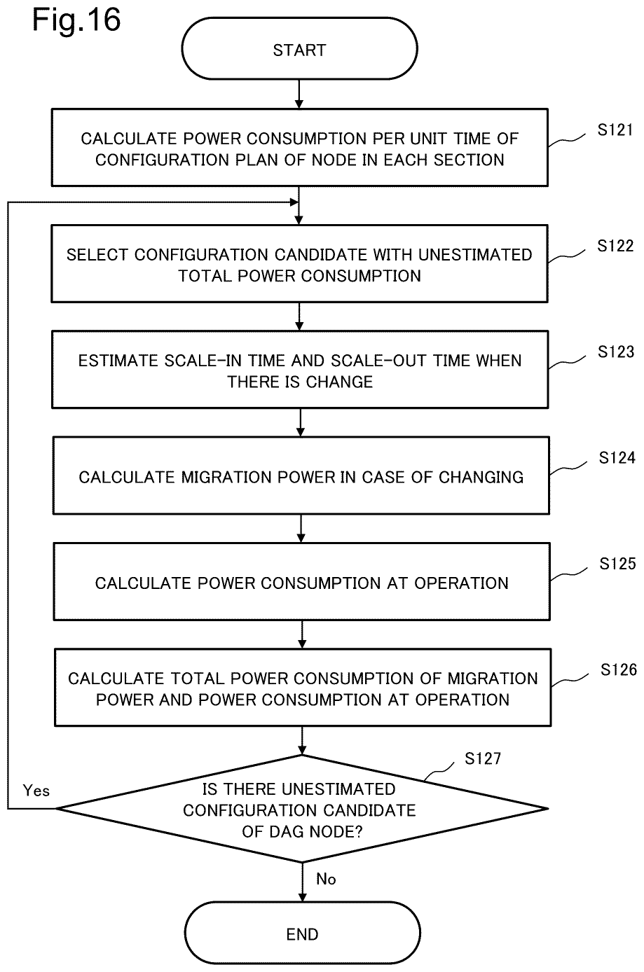

FIG. 16 is a flowchart illustrating an estimation example of power consumption by the operation support device 10. FIG. 16 illustrates a detailed example of step S103 illustrated in FIG. 14. In FIG. 16, an example of calculation of power consumption in a case where a configuration plan of a node is designed for each of a plurality of sections as illustrated in FIG. 15 will be described.

First, the estimation unit 107 calculates the power consumption per unit time of the configuration plan of the node in each section (step S121). Next, the estimation unit 107 selects a configuration candidate for which the total power consumption is not estimated (step S122). The estimation unit 107 estimates a scale-in time and a scale-out time when the configuration of the node is changed for the selected configuration candidate (step S123). For the selected configuration candidate, the estimation unit 107 calculates the migration power when the configuration of the node is changed based on the scale-in time and the scale-out time and the power consumption per unit time of the configuration plan of the node (step S124).

Next, the estimation unit 107 calculates power consumption during the operation for the selected configuration candidate based on the power consumption per unit time of the configuration plan of the node (step S125). The estimation unit 107 calculates the total power consumption of the migration power and the power consumption during the operation for the selected configuration candidate (step S126). The estimation unit 107 determines whether there is an unestimated configuration candidate of the DAG node (step S127). In a case where there is an unestimated configuration candidate of the DAG node (step S127: Yes), the estimation unit 107 returns to step S122. In a case where there is no unestimated configuration candidate of the DAG node (step S127: No), the estimation unit 107 ends the series of processing illustrated in FIG. 16.

As described above, in the first example embodiment, the operation support device 10 designs a plurality of configuration candidates of the service operable DAG node based on the resource amount of the prediction necessary for the operation of the service in the prediction target period for the service operated in the operation target system 11 which is the DAG system. Then, the operation support device 10 estimates the total power consumption of the migration power in a case where the migration to the configuration candidate of the DAG node is performed for each of the plurality of configuration candidates of the DAG node and the power consumption in a case where the operation is performed in the configuration candidate of the DAG node. The operation support device 10 controls the operation target system 11 to operate the service using the configuration of the DAG node selected from among the plurality of configuration candidates of the DAG node based on the power consumption calculated for each of the plurality of configuration candidates of the DAG node. As a result, the operation support device 10 controls the operation target system 11 to operate the service using the configuration of the DAG node selected based on the power consumption in consideration of the migration power. Therefore, it is possible to reduce power consumption when a service is operated in the operation target system 11.

The operation support device 10 designs a plurality of configuration candidates of the DAG node based on the configuration plan of the DAG node in each of the plurality of sections in which the prediction target period is divided for each predetermined time. For example, the operation support device 10 searches for a configuration candidate of a DAG node that can be taken in the prediction target period based on a configuration plan of the DAG node in each of a plurality of sections in which the prediction target period is divided for each predetermined time, thereby designing a plurality of configuration candidates of the DAG node. As a result, the operation support device 10 can select the configuration of the DAG node from various configuration candidates of the DAG node. Therefore, it is possible to reduce power consumption when a service is operated in the operation target system 11.

There are a plurality of predetermined times. For each of a plurality of predetermined times, the operation support device 10 may design a plurality of configuration candidates of the DAG node based on a configuration plan of the DAG node in each of a plurality of sections in which the prediction target period is divided for each predetermined time. As a result, the operation support device 10 can select the configuration of the DAG node from various configuration candidates of the DAG node. Therefore, it is possible to reduce power consumption when a service is operated in the operation target system 11.

The operation support device 10 controls the operation target system 11 to operate a service using the configuration of the DAG node having the lowest power consumption from among the plurality of configuration candidates of the DAG node based on the power consumption calculated for each of the plurality of configuration candidates of the DAG node. As a result, the operation support device 10 can control the operation target system 11 to operate the service using the configuration of the DAG node having the lowest power consumption including the migration power. Therefore, it is possible to reduce power consumption when a service is operated in the operation target system 11.

As a specific example of calculating the migration power, the operation support device 10 calculates, as the migration power, the total value of the product of the power consumption per unit time of the configuration plan of the DAG node of the migration source and the time required for scale-in of the DAG node of the migration source and the product of the power consumption per unit time of the configuration plan of the DAG node of the migration destination and the time required for scale-out of the configuration plan of the DAG node of the migration destination. As a result, the operation support device 10 can calculate the migration power more accurately.

The operation support device 10 estimates the time required for scale-in based on the type of service and the type of the device included in the configuration of the DAG node using the learned model. The learned model is a model in which the relationship between the type of service operated in the past and the type of the device included in the configuration of the DAG node when the service operated in the past is executed in the operation target system 11, and the actual measured value of the time required for scale-in when the service operated in the past is executed is learned. As a result, the operation support device 10 can calculate the migration power more accurately.

The operation support device 10 estimates the time required for scale-out based on the type of service and the type of the device included in the configuration of the DAG node using the learned model. The learned model is a model in which the relationship between the type of service operated in the past and the type of the device included in the configuration of the DAG node when the service operated in the past is executed in the operation target system 11, and the actual measured value of the time required for scale-out when the service operated in the past is executed is learned. As a result, the operation support device 10 can calculate the migration power more accurately.

### Second Example Embodiment

A second example embodiment will be described in detail with reference to the drawings. In a second example embodiment, a process of calculating a resource amount and power consumption in a DAG node configuration will be described. Hereinafter, the description of content that is duplicate of the description above will be omitted to the extent that description of the second example embodiment is not unclear.

In the second example embodiment, since the entire system including a control target system and an operation support device is the same as the example illustrated in FIG. 1, the description of the entire system example is omitted.

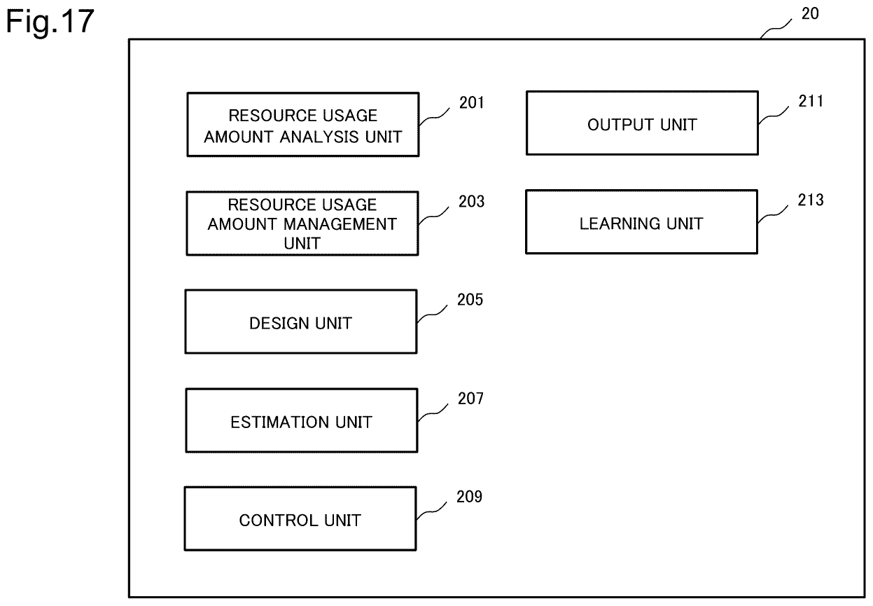

FIG. 17 is a block diagram illustrating a configuration example of an operation support device 20. The operation support device 20 includes a resource usage amount analysis unit 201, a resource usage amount management unit 203, a design unit 205, an estimation unit 207, a control unit 209, an output unit 211, and a learning unit 213. The design unit 205 has the function of the design unit 105 illustrated in FIG. 8 as a basic function. The estimation unit 207 has the function of the estimation unit 107 illustrated in FIG. 8 as a basic function. The control unit 209 has the function of the control unit 109 illustrated in FIG. 8 as a basic function.

The resource usage amount analysis unit 201 analyzes a resource use state of the operation target system and analyzes a resource usage amount associated with a service and a device.

The resource usage amount data refers to a measured value associated with attribute data. The attribute data is, for example, a model number of a device and tag information including a service. The measured value is, for example, a service load, CPU usage rate, memory usage, and power consumption, and is not limited to these examples.

The resource usage amount data is data indicating that the usage amount of the resource acquired in the situation indicated in the attribute data is as indicated in the measured value.

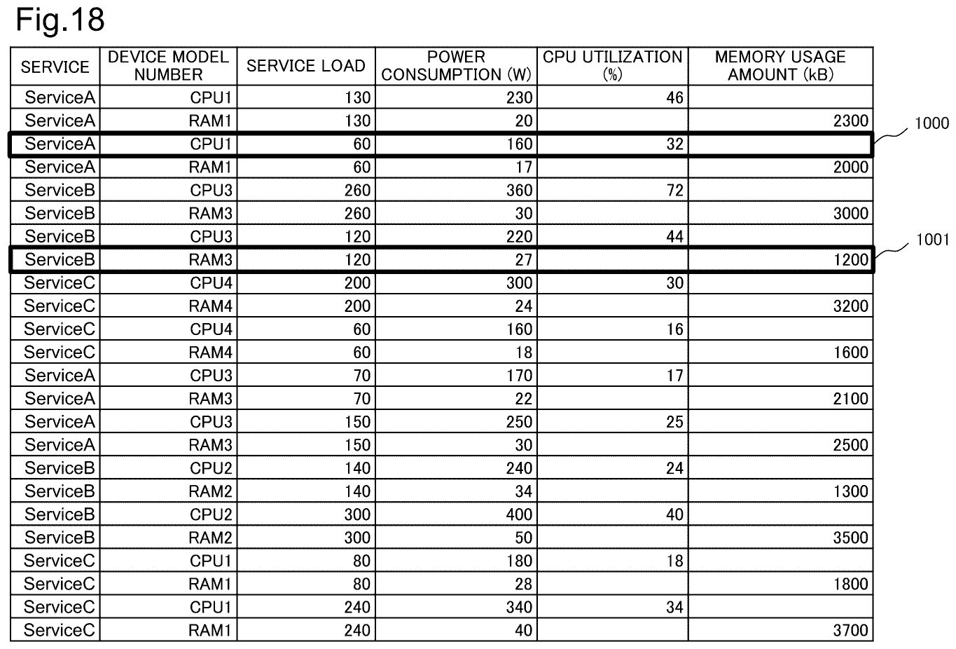

FIG. 18 is an explanatory diagram illustrating an example of data acquired as resource usage amount data. FIG. 18 illustrates 24 pieces of resource usage amount data. The data 1000 indicates that “When a service load 60 is applied to an instance of the service ServiceA, 32% of a usage rate of the CPU1 (on which the instance is hosted) is consumed, and the power consumption derived therefrom is 160 W”. The data 1001 indicates that when a service load 120 is applied to the application instance of the service ServiceB, 1200 kB of the memory capacity of the RAM3 connected to the DAG node in which the instance is hosted is consumed, and the power consumption derived therefrom is 27 W.

An operation in which the resource usage amount analysis unit 201 acquires the resource usage amount will be described.

The specific processing in which the resource usage amount analysis unit 201 acquires the resource usage amount changes according to the resource usage amount to be acquired. Here, it is assumed that all or some of the following four methods are adopted.

### (Method 1)

The resource usage amount analysis unit 201 acquires information using an out-of-band (OOB) method by a management mechanism of a housing or a device base (BMC, Baseboard Management Controller) on which each device is mounted. The resource usage amount analysis unit 201 sends an application programming interface (API) request to an OOB interface included in the BMC, and acquires necessary information. According to this Method 1, the resource usage amount analysis unit 201 can acquire, for example, sensor information such as power consumption acquired by a sensor mounted in the housing, device load information acquired from an interface included in the BMC, and the like.

### (Method 2)

The resource usage amount analysis unit 201 acquires management information via a management mechanism included in a mechanism that controls the entire DAG system. The resource usage amount analysis unit 201 transmits an API request to an interface included in hardware that manages the configuration of the DAG system, and acquires necessary information. According to this Method 2, for example, the resource usage amount analysis unit 201 can acquire specifications of each device, a power state of each device, a state of a connection relationship between devices, and the like.

### (Method 3)

The resource usage amount analysis unit 201 acquires management/performance information via a function of an operating system (OS). The resource usage amount analysis unit 201 acquires necessary information by an execution result of a command embedded in the OS, reference to device information managed by the OS, or the like. According to this Method 3, the resource usage amount analysis unit 201 can acquire the device information managed by the OS.

### (Method 4)

The resource usage amount analysis unit 201 acquires management/performance information via the function of the information acquisition agent introduced into the OS. The information acquisition agent software is introduced into the OS. The resource usage amount analysis unit 201 acquires necessary information by communicating with the OS via the function of the information acquisition agent.

The above is a specific example of the data acquisition method that can be adopted by the resource usage amount analysis unit 201 to acquire the resource usage amount. As a method of acquiring the resource usage amount, the above-described methods may be combined, or other methods may be used.

The resource usage amount management unit 203 manages the resource usage amount data analyzed by the resource usage amount analysis unit 201, and outputs necessary resource usage amount data in response to a request. Here, the resource usage amount management unit 203 has a function of storing data and a function of using data.

As a method of storing data by the resource usage amount management unit 203, a mechanism similar to a general relational database management system (RDBMS) can be adopted. Therefore, for example, the storage function may be implemented by having an existing relational database management system in the back end.

Next, the operation of the function using the resource usage amount by the resource usage amount management unit 203 will be described.

The resource usage amount management unit 203 outputs the resource usage amount based on the information specifying the type of the resource usage amount, the information specifying the range of the resource usage amount to be used, and the information of the service load.

The information for specifying the type of the resource usage amount is information for specifying any of the CPU usage rate, the memory usage amount, and the power consumption.

The information designating the range of the resource usage amount to be used is a set of attribute data associated with the resource usage amount data. For example, “Service: ServiceA, Device model number: CPU1” or the like is relevant to the information.

Details of the operation of the function using the resource usage amount by the resource usage amount management unit 203 will be described. Here, information for specifying the type of resource usage amount is referred to as “data type designation”. Information for specifying a range of resource usage amount to be used is referred to as a “data filter”.

The resource usage amount management unit 203 receives data type designation RESOURCE, a data filter FILTER, and a service load LOAD as inputs.

The resource usage amount management unit 203 extracts data filtered by the attribute information included in the data filter FILTER from the managed resource usage amount data.

The resource usage amount management unit 203 configures a data set (Ld[i], Rsc[i]) (i=0, 1, . . . , N) obtained by extracting only two sets of data of “load” and “RESOURCE” from the extracted data.

The resource usage amount management unit 203 executes curve fitting for the data set (Ld[i], Rsc[i]) (i=0, 1, . . . , N). That is, a univariate function f is obtained such that the value of |Rsc[0]−f(Ld[0])|+|Rsc[1]−f(Ld[1])|+ . . . |Rsc[N]−f(Ld[N])| is as small as possible. |x| represents an absolute value of x.

The function f can be provided with an appropriate constraint. For example, a constraint such as a linear function, a polynomial function, or a monotonically increasing quadratic function is provided as f, and a function that most matches the data set under the constraint may be obtained.

The resource usage amount management unit 203 outputs a value of f(LOAD). When power consumption is designated as RESOURCE, the resource usage amount management unit 203 outputs the power consumption as f(LOAD).

The static power consumption of the device can be obtained by using the function of using the resource usage amount of the resource usage amount management unit 203.

It is assumed that the static power consumption of the device D is obtained using the function of using the resource usage amount of the resource usage amount management unit 203. In this case, for example, a service S may be selected, “service S” may be designated as the data filter, “power consumption” may be designated as the data type designation, and a value when the load is 0 may be output.

However, the method of obtaining the static power consumption of the device D using the function of using the resource usage amount of the resource usage amount management unit 203 is not limited to the above-described method. The method is not limited to the example of using the value obtained by selecting one of the services by the above-described procedure, and it is also conceivable to obtain a statistical value of the value of the static power consumption obtained by the above-described procedure for a plurality of services and use the value as the static power consumption of the device D. The statistical value is, for example, an average value, a mode value, or the like.

The estimation unit 207 may calculate the power consumption at the time of operation of the configuration candidate of the DAG node by using the static power consumption of each device calculated by the resource usage amount management unit 203.

Since the functions of the estimation unit 207, the design unit 205, and the control unit 209 are as described in the first example embodiment, detailed description thereof will be omitted.

The output unit 211 outputs the history of the configuration of the DAG node selected by the control unit 209. The output method is not particularly limited, and examples thereof include storage in a storage unit or the like, screen display, and voice output. For example, the output unit 211 may display the history of the configuration of the selected DAG node on the terminal of the administrator of the operation target system.

For example, the learning unit 213 may update the learned model by learning the learned model capable of outputting the time required for scale-in based on the actual operation result. Specifically, for example, the learning unit 213 updates the learned model by newly learning the relationship among the type of service, the type of the device included in the configuration of the selected DAG node, and the actual measured value of the time required for scale-in in the configuration of the selected DAG node.

For example, the learning unit 213 may update the learned model by learning the learned model capable of outputting the time required for scale-out based on the actual operation result. For example, the learning unit 213 updates the learned model by newly learning the relationship among the type of service, the type of the device included in the configuration of the selected DAG node, and the actual measured value of the time required for scale-out in the configuration of the selected DAG node.

### (Flowchart)

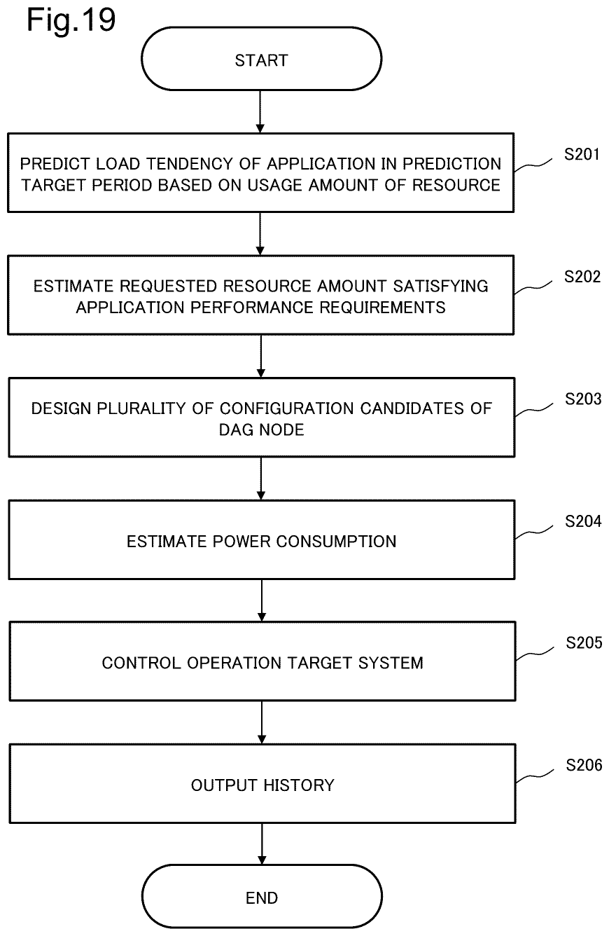

FIG. 19 is a flowchart illustrating an exemplary operation of the operation support device 20. The resource usage amount analysis unit 201 collects the resource usage amount of the application from the operation target system 11 and predicts the load tendency of the application in the future prediction target period by time series analysis or other arbitrary means (step S201). The resource usage amount management unit 203 estimates a necessary resource amount that satisfies the performance requirement of the application at a certain future time point based on the prediction result of the load tendency (step S202).

The design unit 205 designs a plurality of configuration candidates of the service operable DAG node based on the resource amount of the prediction necessary for the operation of the service in the prediction target period for the service to be operated in the DAG system (step S203). Next, the estimation unit 207 estimates the total power consumption of the migration power in a case where the migration to the configuration candidate of the DAG node is performed for each of the plurality of configuration candidates of the DAG node and the power consumption in a case where the operation is performed in the configuration candidate of the DAG node (step S204).

The control unit 209 controls the operation target system 11 to operate the service using the configuration of the DAG node selected from among the plurality of configuration candidates of the DAG node based on the power consumption calculated for each of the plurality of configuration candidates of the DAG node (step S205). The output unit 211 outputs the history of the configuration of the selected DAG node (step S206). Then, the operation support device 20 ends a series of processes illustrated in FIG. 19.

As described above, in the second example embodiment, the operation support device 20 outputs the history of the configuration of the selected DAG node. As a result, for example, the administrator of the operation target system 11 can confirm the configuration of the DAG node.

The operation support device 20 updates the learned model by newly learning the relationship among the type of service, the type of the device included in the configuration of the selected DAG node, and the actual measured value of the time required for scale-in in the configuration of the selected DAG node. As a result, the operation support device 20 can calculate the scale-in time more accurately by performing the additional learning.

The operation support device 20 updates the learned model by newly learning the relationship among the type of service, the type of the device included in the configuration of the selected DAG node, and the actual measured value of the time required for scale-out in the configuration of the selected DAG node. As a result, the operation support device 20 can calculate the scale-out time more accurately by performing the additional learning.

### Third Example Embodiment

A third example embodiment will be described in detail with reference to the drawings. In the third example embodiment, an example in which an administrator outputs information regarding configuration candidates of a DAG node necessary for determining the configuration of the DAG node will be described. In the third example embodiment, an example of accepting selection of a configuration candidate of a DAG node will be described. Hereinafter, the description of content that is duplicate of the description above will be omitted to the extent that description of the third example embodiment is not unclear.

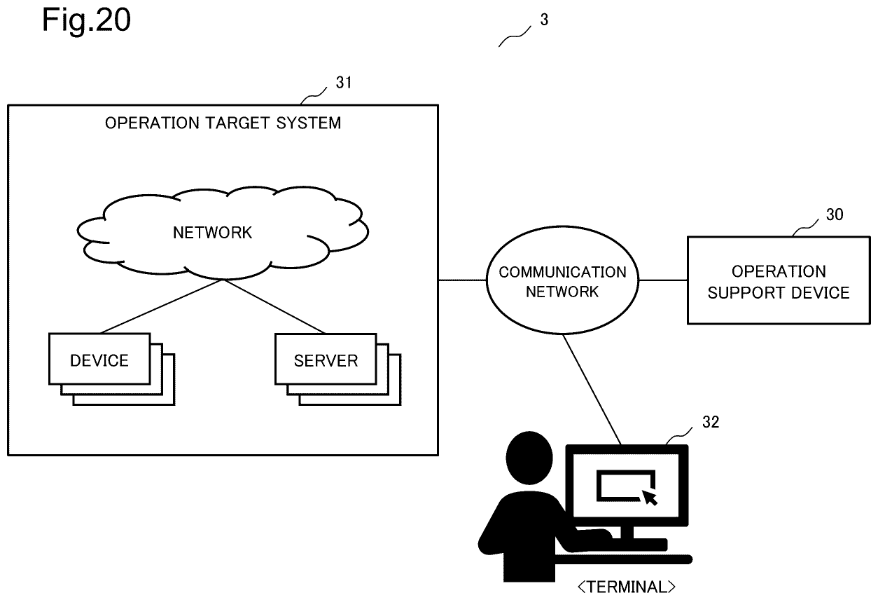

FIG. 20 is an explanatory diagram illustrating an example of a system including the operation support device. A system 3 includes, for example, an operation target system 31, an operation support device 30, and a terminal 32. The operation target system 31 is as described in the first example embodiment. The operation support device 30 is connected to the operation target system 31 and the terminal 32 via a communication network.

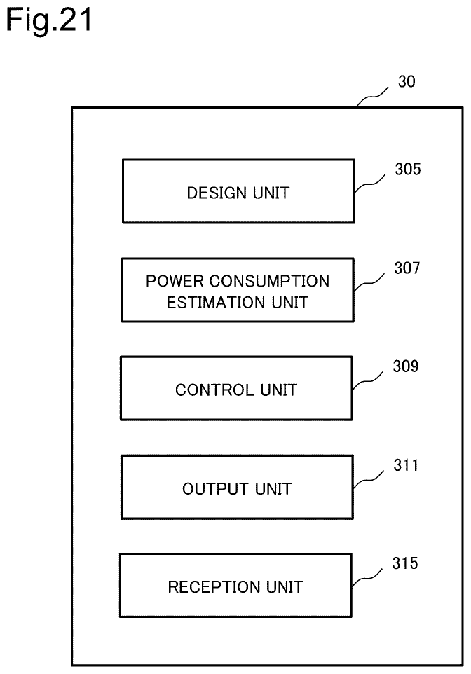

FIG. 21 is a block diagram illustrating a configuration example of the operation support device 30. The operation support device 30 includes a design unit 305, an estimation unit 307, a control unit 309, an output unit 311, and a reception unit 315.

The design unit 305 may have the function of the design unit 105 illustrated in FIG. 8 as a basic function. The estimation unit 307 may have the function of the estimation unit 107 illustrated in FIG. 8 as a basic function. Since the design unit 305 and the estimation unit 307 may be similar to those of the first example embodiment, detailed description thereof is omitted.

The output unit 311 outputs information regarding at least a part of the plurality of configuration candidates of the DAG node based on the power consumption calculated for each of the plurality of configuration candidates of the DAG node. The output destination of the output unit 311 is, for example, the terminal 32 of the administrator who manages the operation target system 31.

Specifically, for example, the output unit 311 may output information regarding a configuration candidate of a DAG node and power consumption in association with each other for each of a plurality of configuration candidates of the DAG node. The information regarding the configuration candidate of the DAG node may be a specific time-series device configuration or identification information capable of identifying the configuration candidate of the DAG node. For example, the output unit 311 may output information regarding the configuration candidates of the DAG node in ascending order of power consumption. Alternatively, for example, the output unit 311 may output information regarding the configuration candidate of the DAG node having the lowest power consumption.

The output unit 311 may output information regarding a configuration candidate of a DAG node so that the configuration of the DAG node can be selected from the configuration candidates of the DAG node.

The reception unit 315 may receive a configuration of a DAG node. For example, the reception unit 315 receives the configuration of the DAG node by an operation on the input device of the terminal 32. For example, the reception unit 315 may receive selection of a configuration of a DAG node from among a plurality of configurations of the DAG node to which information is output.

The control unit 309 controls the operation target system 31 to operate the service using the received configuration of the DAG node. The output unit 311 may output the history of the configuration of the received DAG node, similarly to the second example embodiment.

### (Flowchart)

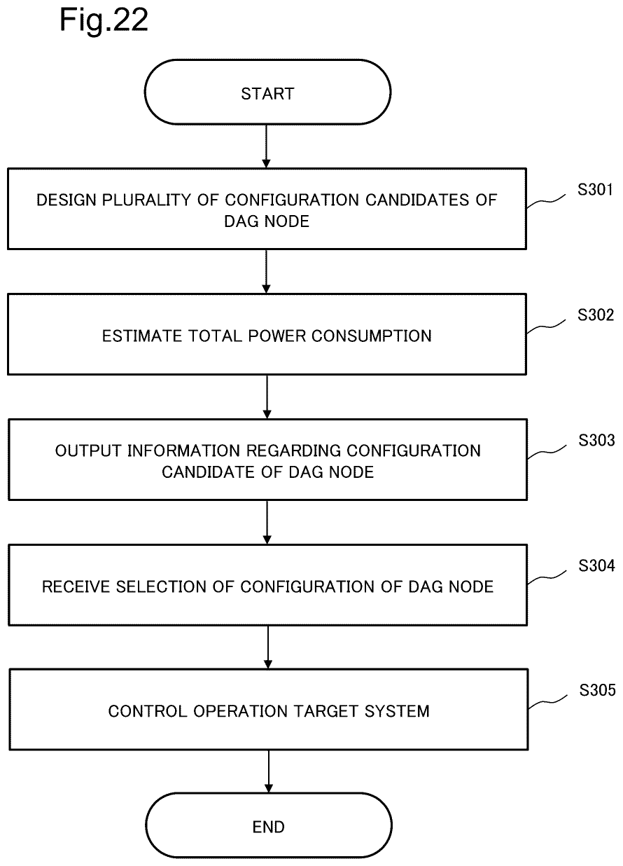

FIG. 22 is a flowchart illustrating an exemplary operation of the operation support device 30. The design unit 305 designs a plurality of configuration candidates of the service operable DAG node based on the resource amount of the prediction necessary for the operation of the service in the prediction target period for the service to be operated in the operation target system 31 (step S301). Next, the estimation unit 307 estimates the total power consumption of the migration power in a case where the migration to the configuration candidate of the DAG node is performed for each of the plurality of configuration candidates of the DAG node and the power consumption in a case where the operation is performed in the configuration candidate of the DAG node (step S302).

The output unit 311 outputs information regarding at least a part of the plurality of configuration candidates of the DAG node based on the power consumption calculated for each of the plurality of configuration candidates of the DAG node (step S303).

The reception unit 315 accepts the selection of the configuration of the DAG node (step S304). The control unit 309 controls the operation target system 31 to operate the service using the configuration of the selected DAG node (step S305). Then, the operation support device 30 ends a series of processes illustrated in FIG. 22.

As described above, in the third example embodiment, the operation support device 30 designs a plurality of configuration candidates of the service operable DAG node based on the resource amount of the prediction necessary for the operation of the service in the prediction target period for the service operated in the operation target system 31. The operation support device 30 estimates the total power consumption of the migration power in a case where the migration to the configuration candidate of the DAG node is performed for each of the plurality of configuration candidates of the DAG node and the power consumption in a case where the operation is performed in the configuration candidate of the DAG node. Then, the operation support device 30 outputs information regarding at least a part of the plurality of configuration candidates of the DAG node based on the power consumption calculated for each of the plurality of configuration candidates of the DAG node. The administrator of the operation target system 31 can select the DAG node using the output information. The operation support device 30 may output the configuration candidates of the DAG node in ascending order of power consumption. As a result, the administrator can confirm the configuration candidate of the DAG node with low power consumption.

The operation support device 30 accepts the selection of the configuration of the DAG node from a plurality of configuration candidates of the DAG node. Then, the operation support device 30 controls the operation target system 31 to operate the service using the configuration of the selected DAG node. As a result, the service can be operated using the configuration of the DAG node selected by the administrator.

Thus, the description of each example embodiment ends. The example embodiments are not limited to the examples described above, and various modifications can be made. The example embodiments may be combined as appropriate. There is no particular limitation on how example embodiments are combined with each other. For example, the operation support device 30 may further include a resource usage amount analysis unit 201, a resource usage amount management unit 203, and a learning unit 213. The operation support devices 10, 20, and 30 may be configured to include some functional units. For example, the operation support device 20 may include a resource usage amount analysis unit 201, a resource usage amount management unit 203, a design unit, an estimation unit 207, and a control unit 209.

The various sorts of information are examples and may further include other information or may not include some information.

Processing of generating information or the like to be displayed on the terminal 32 may be performed by the output unit 311. This processing may be performed by the terminal 32. That is, the terminal 32 may generate screen information to be displayed on the terminal 32, based on the data received from the operation support device 30, and display a screen, based on the screen information. User interfaces in the example embodiments are examples, and various changes can be made.

### (Hardware Configuration Example of Computer)

Next, a hardware configuration example in a case where each device such as the operation support devices 10, 20, and 30 and the terminal 32 is implemented by a computer will be described.

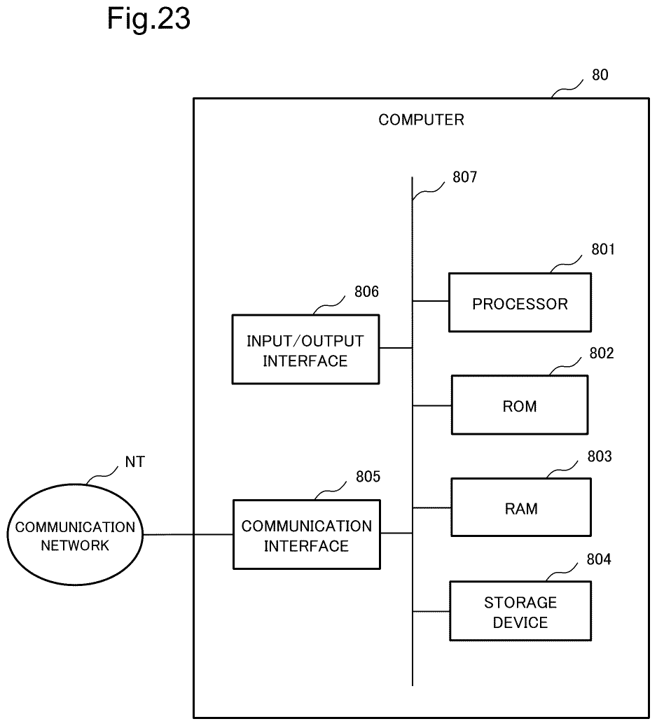

FIG. 23 is an explanatory diagram illustrating a hardware configuration example of the computer. For example, some or all of the devices can be implemented by using any combination of a computer 80 and a program as illustrated in FIG. 23.

The computer 80 includes, for example, a processor 801, a ROM 802, a RAM 803, and a storage device 804. The computer 80 also includes a communication interface 805 and an input/output interface 806. The constituents are connected to each other via a bus 807, for example. The number of constituents is not particularly limited, and one or more constituents are provided.

The processor 801 controls the entire computer 80. As the processor 801, for example, a CPU, a digital signal processor (DSP), a GPU, a physics processing unit (PPU), a tensor processing unit (TPU), a quantum processor, or a combination thereof, or the like can be used and is not particularly limited.

The computer 80 includes the ROM 802, the RAM 803, the storage device 804, and the like. Examples of the storage device 804 include a semiconductor memory such as a flash memory, an HDD, and a solid state drive (SSD). For example, the storage device 804 stores an OS program, an application program, a program according to each example embodiment, and the like. Alternatively, the ROM 802 stores an application program, a program according to the example embodiments, and the like. The RAM 803 is used as a work area for the processor 801.

The processor 801 loads a program stored in the storage device 804, the ROM 802, or the like. The processor 801 executes each process coded in the program. The processor 801 may download various programs via a communication network NT. The processor 801 functions as a part or the whole of the computer 80. The processor 801 may execute the processes or instructions in the flowcharts illustrated in the drawings, based on the program.

The communication interface 805 is connected to the communication network NT such as a local area network (LAN) or a wide area network (WAN) through a wireless or wired communication line. The communication network NT may be constituted by a plurality of communication networks NT. As a result, the computer 80 is connected to an external device or an external computer 80 via the communication network NT. The communication interface 805 takes control of an interface between the communication network NT and the inside of the computer 80. The communication interface 805 controls input and output of data from the external device or the external computer 80.

The input/output interface 806 is connected to at least any one of an input device, an output device, and an input/output device. A method of the connection may be wireless or wired. Examples of the input device include a keyboard, a mouse, and a microphone. Examples of the output device include a display device, a lighting device (such as a lamp), and a sound output device that outputs a sound. Examples of the input/output device include a touch panel display. The input device, the output device, the input/output device, and the like may be built in the computer 80 or may be externally attached to the computer 80. That is, for example, the computer 80 may include an input device such as a keyboard or a mouse. The computer 80 may include an output device such as a display. The computer 80 may include each of an input device, an output device, and an input/output device.

The hardware configuration of the computer 80 is an example. The computer 80 may include some components illustrated in FIG. 23. The computer 80 may include components other than those illustrated in FIG. 23. For example, the computer 80 may include a drive device. The processor 801 may read a program or data stored in a recording medium attached to a drive device or the like into the RAM 803. Examples of the non-transitory tangible recording medium include an optical disk, a flexible disk, a magneto-optical disk, and a Universal Serial Bus (USB) memory.

The computer 80 may include various sensors (not illustrated). A type of the sensor is not particularly limited. The computer 80 may include an imaging device capable of capturing images and videos.

Thus, the description of the hardware configuration of each device has ended. A method of implementing each device has various modifications. For example, each device may be implemented by any combination of a computer and a program different for each component. A plurality of components included in each device may be implemented by any combination of one computer and a program.

Some or all of components of each device may be implemented by an application specific circuit. Some or all of the components of each device may be implemented by a general-purpose circuit such as a field programmable gate array (FPGA). Some or all of the components of each device may be implemented by a combination of an application specific circuit, a general-purpose circuit, and the like. The circuit may be a single integrated circuit. Alternatively, the circuit may be divided into a plurality of integrated circuits. The plurality of integrated circuits may be configured by being connected via a bus or the like.

In a case where some or all of the components of each device are implemented by a plurality of computers, circuits, and the like, the plurality of computers, circuits, and the like may be disposed in a centralized manner or in a distributed manner.

The operation support method described in each example embodiment may be executed and implemented by a computer such as the operation support devices 10, 20, and 30.

Each program described in each example embodiment is recorded in a computer-readable recording medium such as an HDD, an SSD, a flexible disk, an optical disc, a magneto-optical disc, or a USB memory. Each program is read from the recording medium by the computer to be executed. Each program may be distributed via the communication network NT.

The function of each component of the operation support devices 10, 20, and 30 described above may be implemented by dedicated hardware such as a computer. Alternatively, the components may be implemented by software. Alternatively, the components may be implemented by a combination of hardware and software.

While the present disclosure has been particularly shown and described with reference to example embodiments thereof, the present disclosure is not limited to these example embodiments. The configurations and details of the present disclosure may include example embodiments to which various changes that can be grasped by those skilled in the art within the scope of the present disclosure are applied. The present disclosure may include example embodiments in which the matters described in the present specification are appropriately combined or replaced, as necessary. For example, the matters described with a specific example embodiment can be applied to other example embodiments as long as no contradiction occurs. For example, although a plurality of operations is described in order in the form of a flowchart, the described order does not limit the order in which the plurality of operations is executed. Thus, when each example embodiment is carried out, the order of the plurality of operations can be changed within a range that does not interfere with the content.

Some or all of the example embodiments described above may also be described as Supplementary Notes below. However, some or all of the example embodiments described above are not limited to the following.

### (Supplementary Note 1)

An operation support device including:
a design means for designing a plurality of configuration candidates of a service operable disaggregated (DAG) node based on a resource amount of prediction necessary for operation of a service to be operated in a prediction target period for the service to be operated in a DAG system;
an estimation means for estimating a total power consumption of a migration power in a case where a migration to a configuration candidate of the DAG node is performed for each of a plurality of configuration candidates of the DAG node and power consumption in a case where operation is performed in the configuration candidate of the DAG node; and
a control means for controlling the DAG system to operate the service using a configuration of the DAG node selected from among a plurality of configuration candidates of the DAG node based on the power consumption calculated for each of the plurality of configuration candidates of the DAG node.

### (Supplementary Note 2)

The operation support device according to Supplementary Note 1, in which
the design means designs a plurality of configuration candidates of the DAG node based on a configuration plan of the DAG node in each of a plurality of sections in which the prediction target period is divided for each predetermined time.

### (Supplementary Note 3)

The operation support device according to Supplementary Note 2, in which
the design means designs a plurality of configuration candidates of the DAG node by searching for a configuration candidate of a DAG node that can be taken in the prediction target period based on a configuration plan of the DAG node in each of the plurality of sections in which the prediction target period is divided for each predetermined time.

### (Supplementary Note 4)

The operation support device according to Supplementary Note 2 or 3, in which
there are a plurality of the predetermined times.

### (Supplementary Note 5)

The operation support device according to any one of Supplementary Notes 1 to 4, in which
the control means controls the DAG system to operate the service using a configuration of a DAG node having a lowest power consumption from among a plurality of configuration candidates of the DAG node based on the power consumption calculated for each of the plurality of configuration candidates of the DAG node.

### (Supplementary Note 6)

The operation support device according to any one of Supplementary Notes 1 to 5, further including
an output means for outputting a history of a configuration of the selected DAG node.

### (Supplementary Note 7)

The operation support device according to any one of Supplementary Notes 1 to 6, in which
the estimation means calculates, as the migration power, a total value of a product of power consumption per unit time of a configuration plan of a DAG node of a migration source and time required for scale-in of the DAG node of the migration source and a product of power consumption per unit time of a configuration plan of a DAG node of a migration destination and time required for scale-out of the configuration plan of the DAG node of the migration destination.

### (Supplementary Note 8)

The operation support device according to Supplementary Note 7, in which
the estimation means estimates the time required for the scale-in based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-in when the service operated in the past is executed is learned.

### (Supplementary Note 9)

The operation support device according to Supplementary Note 8, further including
a learning means for updating the learned model by newly learning a relationship among a type of service, a type of a device included in a configuration of the selected DAG node, and an actual measured value of time required for scale-in in the configuration of the selected DAG node.

### (Supplementary Note 10)

The operation support device according to Supplementary Note 7, in which
the estimation means estimates the time required for the scale-out based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-out when the service operated in the past is executed is learned.

### (Supplementary Note 11)

The operation support device according to Supplementary Note 10, further including
a learning means for updating the learned model by newly learning a relationship among a type of service, a type of a device included in a configuration of the selected DAG node, and an actual measured value of time required for scale-out in the configuration of the selected DAG node.

### (Supplementary Note 12)

An operation support device including:
a design means for designing a plurality of configuration candidates of a service operable DAG node based on a resource amount of prediction necessary for operation of a service to be operated in a prediction target period for the service to be operated in a DAG system;
an estimation means for estimating a total power consumption of a migration power in a case where a migration to a configuration candidate of the DAG node is performed for each of a plurality of configuration candidates of the DAG node and power consumption in a case where operation is performed in the configuration candidate of the DAG node; and
an output means for outputting information regarding at least a part of a plurality of configuration candidates of the DAG node based on the power consumption calculated for each of the plurality of configuration candidates of the DAG node.

### (Supplementary Note 13)

The operation support device according to Supplementary Note 12, including:
a reception means for receiving selection of a configuration of a DAG node from a plurality of configuration candidates of the DAG node; and
a control means for controlling the DAG system to operate the service by using a configuration of the selected DAG node.

### (Supplementary Note 14)

The operation support device according to Supplementary Note 12 or 13, in which
the design means designs a plurality of configuration candidates of the DAG node based on a configuration plan of the DAG node in each of a plurality of sections in which the prediction target period is divided for each predetermined time.

### (Supplementary Note 15)

The operation support device according to Supplementary Note 14, in which
the design means designs a plurality of configuration candidates of the DAG node by searching for a configuration candidate of a DAG node that can be taken in the prediction target period based on a configuration plan of the DAG node in each of the plurality of sections in which the prediction target period is divided for each predetermined time.

### (Supplementary Note 16)

The operation support device according to Supplementary Note 14 or 15, in which
there are a plurality of the predetermined times.

### (Supplementary Note 17)

The operation support device according to Supplementary Note 13, in which
the output means outputs a history of a configuration of the DAG node.

### (Supplementary Note 18)

The operation support device according to any one of Supplementary Notes 12 to 17, in which
the estimation means calculates, as the migration power, a total value of a product of power consumption per unit time of a configuration plan of a DAG node of a migration source and time required for scale-in of the DAG node of the migration source and a product of power consumption per unit time of a configuration plan of a DAG node of a migration destination and time required for scale-out of the configuration plan of the DAG node of the migration destination.

### (Supplementary Note 19)

The operation support device according to Supplementary Note 18, in which
the estimation means estimates the time required for the scale-in based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-in when the service operated in the past is executed is learned.

### (Supplementary Note 20)

The operation support device according to Supplementary Note 19, further including
a learning means for updating the learned model by newly learning a relationship among a type of service, a type of a device included in a configuration of the selected DAG node, and an actual measured value of time required for scale-in in the configuration of the selected DAG node.

### (Supplementary Note 21)

The operation support device according to Supplementary Note 18, in which
the estimation means estimates the time required for the scale-out based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-out when the service operated in the past is executed is learned.

### (Supplementary Note 22)

The operation support device according to Supplementary Note 21, further including
a learning means for updating the learned model by newly learning a relationship among a type of service, a type of a device included in a configuration of the selected DAG node, and an actual measured value of time required for scale-out in the configuration of the selected DAG node.

### (Supplementary Note 23)

An operation support method for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
controlling the DAG system to operate the service using a configuration of the DAG node selected from among a plurality of configuration candidates of the DAG node based on the power consumption calculated for each of the plurality of configuration candidates of the DAG node.

### (Supplementary Note 24)

An operation support method for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
outputting information regarding at least a part of a plurality of configuration candidates of the DAG node based on the power consumption calculated for each of the plurality of configuration candidates of the DAG node.

### (Supplementary Note 25)

A program for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
controlling the DAG system to operate the service using a configuration of the DAG node selected from among a plurality of configuration candidates of the DAG node based on the power consumption calculated for each of the plurality of configuration candidates of the DAG node.

### (Supplementary Note 26)

A program for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
outputting information regarding at least a part of a plurality of configuration candidates of the DAG node based on the power consumption calculated for each of the plurality of configuration candidates of the DAG node.

### (Supplementary Note 27)

A non-transitory computer-readable recording medium having recorded therein a program for causing at least one computer to execute:
designing a plurality of configuration candidates of a service operable disaggregated (DAG) node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
controlling the DAG system to operate the service using a configuration of the DAG node selected from among a plurality of configuration candidates of the DAG node based on the power consumption calculated for each of the plurality of configuration candidates of the DAG node.

### (Supplementary Note 28)

A non-transitory computer-readable recording medium having recorded therein a program for causing at least one computer to execute:
designing a plurality of configuration candidates of a service operable disaggregated (DAG) node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
outputting information regarding at least a part of a plurality of configuration candidates of the DAG node based on the power consumption calculated for each of the plurality of configuration candidates of the DAG node.

Some or all of the configurations described in Supplementary Notes 2 to 11 subordinate to Supplementary Note 1 described above can also be subordinate to Supplementary Notes 23, 25, and 27 with a subordinate relationship similar to that of Supplementary Notes 2 to 11. Some or all of the configurations described in Supplementary Notes 13 to 22 subordinate to Supplementary Note 12 described above can also be subordinate to Supplementary Notes 24, 26, and 28 with a subordinate relationship similar to that of Supplementary Notes 13 to 22. Some or all of the configurations described as Supplementary Notes can be similarly subordinate to not only Supplementary Notes 1, 12, 23, 24, 25, 26, 27, and 28, but also various pieces of hardware and software, and a variety of recording means for recording software, or a system without departing from the above-described example embodiments.

According to the present disclosure, it is possible to reduce power consumption when operating a service in a DAG system.

1. An operation support device comprising:
at least one memory configured to store instructions; and
at least one processor configured to execute the instructions to:
design a plurality of configuration candidates of a service operable disaggregated (DAG) node based on a resource amount of prediction necessary for operation of a service to be operated in a prediction target period for the service to be operated in a DAG system;
estimate a total power consumption of a migration power in a case where a migration to a configuration candidate of the DAG node is performed for each of a plurality of configuration candidates of the DAG node and power consumption in a case where operation is performed in the configuration candidate of the DAG node; and
control the DAG system to operate the service using a configuration of the DAG node selected from among a plurality of configuration candidates of the DAG node based on the power consumption calculated for each of the plurality of configuration candidates of the DAG node.

2. The operation support device according to claim 1, wherein the at least one processor is further configured to execute the instructions to:
design a plurality of configuration candidates of the DAG node based on a configuration plan of the DAG node in each of a plurality of sections in which the prediction target period is divided for each predetermined time.

3. The operation support device according to claim 2, wherein the at least one processor is further configured to execute the instructions to: design a plurality of configuration candidates of the DAG node by searching for a configuration candidate of a DAG node that can be taken in the prediction target period based on a configuration plan of the DAG node in each of the plurality of sections in which the prediction target period is divided for each predetermined time.

4. The operation support device according to claim 1, wherein the at least one processor is further configured to execute the instructions to: control the DAG system to operate the service using a configuration of a DAG node having a lowest power consumption from among a plurality of configuration candidates of the DAG node based on the power consumption calculated for each of the plurality of configuration candidates of the DAG node.

5. The operation support device according to claim 1, wherein the at least one processor is further configured to execute the instructions to:
output a history of a configuration of the selected DAG node.

6. The operation support device according to claim 1, wherein the at least one processor is further configured to execute the instructions to:
calculate, as the migration power, a total value of a product of power consumption per unit time of a configuration plan of a DAG node of a migration source and time required for scale-in of the DAG node of the migration source and a product of power consumption per unit time of a configuration plan of a DAG node of a migration destination and time required for scale-out of the configuration plan of the DAG node of the migration destination.

7. The operation support device according to claim 6, wherein the at least one processor is further configured to execute the instructions to:
estimate the time required for the scale-in based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-in when the service operated in the past is executed is learned.

8. The operation support device according to claim 6, wherein the at least one processor is further configured to execute the instructions to:
estimate the time required for the scale-out based on a type of the service and a type of a device included in a configuration of the DAG node by using a learned model, and
the learned model is a model in which a relationship among a type of a service operated in a past in the DAG system, a type of a device included in a configuration of a DAG node when the service operated in the past is executed, and an actual measured value of a time required for scale-out when the service operated in the past is executed is learned.

9. An operation support method for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
controlling the DAG system to operate the service using a configuration of the DAG node selected from among a plurality of configuration candidates of the DAG node based on the power consumption calculated for each of the plurality of configuration candidates of the DAG node.

10. A non-transitory computer-readable recording medium having recorded therein a program for causing at least one computer to execute:
designing a plurality of configuration candidates of a service operable DAG node based on a resource amount of prediction necessary for operation of a service to be operated in a prediction target period for the service to be operated in a DAG system;
estimating a total power consumption of a migration power in a case where a migration to a configuration candidate of the DAG node is performed for each of a plurality of configuration candidates of the DAG node and power consumption in a case where operation is performed in the configuration candidate of the DAG node; and
controlling the DAG system to operate the service using a configuration of the DAG node selected from among a plurality of configuration candidates of the DAG node based on the power consumption calculated for each of the plurality of configuration candidates of the DAG node.
